(19) United States
(12) Patent Application Publication
(10) Pub. No.: US 2015/0206646 A1
(43) Pub. Date: Jul. 23, 2015

(54) METHODS AND APPARATUS FOR IMPROVING WINDING BALANCE ON INDUCTIVE DEVICES

(71) Applicant: Pulse Electronics, Inc., San Diego, CA (US)

(72) Inventors: Thuyen Dinh, San Diego, CA (US); Mohammad Saboori, San Diego, CA (US); Aurelio Gutierrez, San Diego, CA (US); Collin Kneifl, San Diego, CA (US); Thomas Rascon, San Diego, CA (US); Farid Hamidy, San Diego, CA (US)

(21) Appl. No.: 14/550,739

(22) Filed: Nov. 21, 2014

Related U.S. Application Data
(60) Provisional application No. 61/916,021, filed on Dec. 13, 2013.

(51) Int. Cl. H01F 27/28

(52) U.S. Cl. CPC H01F 27/2823

(57) ABSTRACT

Improved balance winding of electronic components including common-mode chokes and methods for using and manufacturing the same. In one embodiment, the common-mode choke includes a core and a pair of windings. The first winding and the second winding are alternatingly wound around the core with each respective winding being flipped at least once over the traverse direction of the winding barrel of the core. In one variant, the number of flips is dependent upon the core geometry, number of windings, and/or the specification limits on electrical balance. In another variant, the windings are first twisted and/or braided prior to being wound onto the winding barrel of the core.

### PRIORITY

This application claims the benefit of priority to co-owned U.S. Provisional Patent Application Ser. No. 61/916,021 of the same title filed Dec. 13, 2013, the contents of which are incorporated herein by reference in its entirety.

### COPYRIGHT

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### TECHNOLOGICAL FIELD

The present disclosure relates generally to conductors and circuit elements and more particularly in one exemplary aspect to apparatus for improving winding balance on electronic components, and methods of utilizing and manufacturing the same.

### DESCRIPTION OF RELATED TECHNOLOGY

I-shaped cores are commonly used in the design of inductive devices including as, for example, inductors (e.g., using a single winding) and common-mode chokes (e.g., using two or more windings). In the case of common-mode chokes with two or more windings, electrical balance of the windings is becoming more paramount within certain common-mode choke applications.

FIG. I illustrates one such prior art common-mode choke 100. The illustrated choke has flanges 102 disposed on opposite ends of a winding barrel of a core 104, and two windings 106, 108 that are disposed upon the winding barrel. The windings in the single layer choke 100 are wound such that the electrical balance can often be degraded as the signal traveling in a particular turn on one of the wires 106 will always be coupled in the same manner to the next turn of the other wire 108. This small, uneven coupling can add up over the winding length of the winding barrel of core, resulting in an unacceptable imbalance in many modern day applications.

FIG. 2 illustrates an alternative prior art common-mode choke 200 having two or more layers of windings. Similar to that shown with respect to FIG. 1, the illustrated choke has flanges 202 disposed on opposite ends of a winding barrel of a core 204, with two windings 206, 208 being disposed upon the winding barrel. The lower winding 206 is wound under the higher winding 208 causing the wire length of the lower winding 206 to be shorter than the upper winding 208 which results in degradation of electrical balance for the choke.

Accordingly, despite the variety of prior art techniques for winding, for example, common-mode chokes, there is a salient need for winding configurations that are both low in cost to manufacture and offer improved electrical balance over prior art devices. Ideally such a solution would not only offer very low manufacturing cost and improved electrical balance for the device, but also provide a high level of consistency and reliability of performance by limiting opportunities for errors or other imperfections during manufacture of the windings.

### SUMMARY

The present disclosure satisfies the aforementioned needs by providing an improved balance winding for, inter alia, common-mode chokes and methods of using and manufacturing the same.

In a first aspect, an inductive device is disclosed. In one embodiment, the inductive device comprises a common-mode choke having a core that includes a winding barrel with two (2) flanges disposed at opposing ends of the winding barrel; a first winding; and a second winding. The first winding and the second winding are wound about the winding barrel of the core such that in a first portion of the winding barrel, the first winding is wound a first distance from the core and the second winding is wound a second distance from the core with the first distance being shorter than the second distance and at a second portion of the winding barrel, the first winding and the second winding are flipped such that the second winding is wound the first distance from the core and the first winding is wound the second distance from the core.

In a variant, the core comprises an I-shaped core.

In another variant, the first winding and the second winding are flipped a plurality of times along a traversing direction of the winding barrel.

In yet another variant, the number of times that the first and second windings are flipped is selected such that the common-mode choke has increased balance at a higher frequency than a common-mode choke that does not have the plurality of flips.

In yet another variant, the number of times chosen is an odd number.

In yet another variant, the winding barrel has a plurality of sides and the flips of the first and second windings occur on at least two sides of the winding barrel.

In yet another variant, the two sides includes at least two opposing sides of the winding barrel.

In yet another variant, the winding barrel comprises a cylindrical winding barrel and at least two of the plurality of flips of the first and second windings occurs on at least two distinct points along the circumference of the winding barrel.

In yet another variant, the first winding and the second winding collectively comprises a twisted winding characterized as having a plurality of flips over a given turn.

In yet another variant, the twisted winding is secured to a plurality of distinct terminations, each of the distinct terminations occurring on the flanges of the core.

In yet another variant, the first winding and the second winding collectively comprise multiple layers of windings about the winding barrel of the core.

In yet another variant, a length of the first winding is substantially equal to a length of the second winding.

In yet another variant, the winding barrel includes at least a portion of the winding barrel that is substantially free from the first winding and the second winding.

In a second embodiment of the common-mode choke, the first winding and the second winding are wound about the winding barrel of the core, the wound first and second windings includes one or more flips.

In a variant, the one or more flips includes a plurality of flips, the plurality of flips occurring no more than once per a given turn of the first and second winding.

In another variant, the one or more flips includes a plurality of flips, the plurality of flips occurring a plurality of times over a given turn of the first and second winding.

In yet another variant, a length of the first winding is substantially equal to a length of the second winding.

In yet another variant, the winding barrel includes at least a portion of the winding barrel that is substantially free from the first winding and the second winding.

In yet another variant, the first winding and the second winding collectively comprises a twisted pair winding.

In yet another variant, the first winding and the second winding collectively comprise multiple layers of windings about the winding barrel of the core.

In yet another variant, the first winding and the second winding are alternatingly wound around the core with the winding being flipped at least once which changes the wire order in the traverse direction.

In yet another variant, the winding is flipped an odd number of times.

In yet another variant, the number of flips is dependent on the core geometry, wires, and/or the specification limits on electrical balance.

In yet another variant, the number of flips limit the phase of the unbalanced signal from becoming too large to be effectively canceled.

In a second aspect, methods of manufacturing the aforementioned inductive devices are disclosed. In one embodiment, the method includes obtaining a core having a winding barrel; obtaining a first conductive wire and a second conductive wire; winding the first conductive wire and the second conductive wire about the winding barrel of the core; flipping the first conductive wire and the second conductive wire one or more times as the first and second conductive wires are wound about the winding barrel; and securing respective ends of the first and second conductive wires to the core.

In a third aspect, a technique for reducing electrical imbalance in the aforementioned inductive devices is disclosed.

In a fourth aspect, methods of using the aforementioned inductive devices are disclosed.

### BRIEF DESCRIPTION OF THE DRAWINGS

The features, objectives, and advantages of the disclosure will become more apparent from the detailed description set forth below taken in conjunction with the drawings, wherein:

FIG. 1 is a perspective view of a prior art common-mode choke having a single-layer bifilar winding.

FIG. 2 is a perspective view of the underside of a prior art common-mode choke having a multiple-layer bifilar winding.

FIG. 3 is a perspective view of a first exemplary embodiment of a common-mode choke having twisted wire in accordance with the principles of the present disclosure.

FIG. 4 is a perspective view of a second exemplary embodiment of a common-mode choke in accordance with the principles of the present disclosure.

FIG. 5 is a perspective view of a third exemplary embodiment of a common-mode choke having multiple layers in accordance with the principles of the present disclosure.

FIG. 6 is a perspective view of a fourth exemplary embodiment of a common mode choke having multiple layers with multiple wire flips in accordance with the principles of the present disclosure.

FIG. 7 is a process flow diagram illustrating a first exemplary embodiment of a method for manufacturing the common-mode choke illustrated in FIGS. 4-6.

FIG. 8 is a process flow diagram illustrating a second exemplary embodiment of a method for manufacturing the common-mode choke illustrated in FIG. 3.

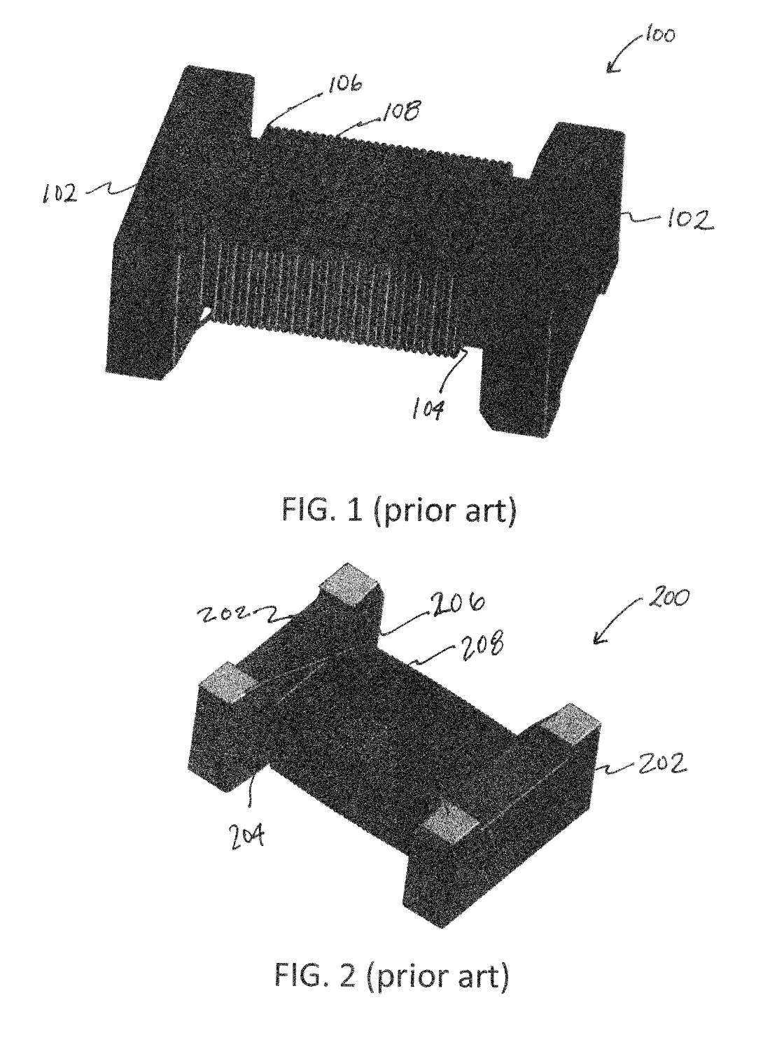

All Figures disclosed herein are © Copyright 2013 Pulse Electronics, Inc. All rights reserved.

### DETAILED DESCRIPTION OF EXEMPLARY EMBODIMENTS

Reference is now made to the drawings, wherein like numerals refer to like parts throughout.

As used herein, the terms “electrical component” and “'electronic component” are used interchangeably and refer to components adapted to provide some electrical and/or signal conditioning function, including without limitation inductive reactors (“choke coils”), transformers, filters, transistors, gapped core toroids, inductors (coupled or otherwise), capacitors, resistors, operational amplifiers, and diodes, whether discrete components or integrated circuits, whether alone or in combination.

As used herein, the term “magnetically permeable” refers to any number of materials commonly used for forming inductive cores or similar components, including without limitation various formulations made from ferrite.

As used herein, the terms “top”, “bottom”, “side”, “up”, “down” and the like merely connote a relative position or geometry of one component to another, and in no way connote an absolute frame of reference or any required orientation. For example, a “top” portion of a component may actually reside below a “bottom” portion when the component is mounted to another device (e.g., to the underside of a PCB).

### Overview

The present disclosure provides, inter alia, improved electrical balance for the windings of electronic components such as common-mode chokes that utilize I-shaped cores. In one embodiment, the electrical balance is a measure of the ratios between the common-mode signals coming from one end of the winding to the differential-mode signals coming out the other end of the winding. In order to improve upon the electrical balance, modifications of the winding process are performed. These modifications can produce a more favorable electrical balance as the small uneven coupling present within prior art winding techniques can add up over the winding length of the core resulting in an unacceptable imbalance in many modern applications.

One such modification is to twist the two (or more) windings prior to winding them onto the winding barrel of the core. Such a winding technique will cause the electrical coupling of the signal from one turn of a winding to the next turn of the other winding to be continuously changed, and hence, accumulated uneven coupling can be minimized or avoided altogether.

In an alternative configuration, the winding technique involves the flipping of the order of the wire pairs every predetermined number of turns. This enables the uneven coupling to reverse direction periodically therefore nullifying the accumulated uneven coupling effects. The number of flips may be dependent on core geometry, geometry and number of wires, as well as the specification limits on electrical balance. For example, common-mode chokes requiring more balance at high frequencies often necessitate more flips in order to limit the size of unbalanced sections of windings. These smaller sections will limit the phase of the unbalanced signal from becoming too large to be effectively cancelled. Since this technique often involves flipping the wire in order to counterbalance the unbalance accumulated in the preceding section, an odd number of flips may be optimal. However, an even number of flips may be utilized as well in certain applications. Furthermore, these windings may be comprised of twisted pair windings or alternatively, weaved windings as well.

These windings may be made from single or multiple layers. For single-layer windings, flipping will change the wire order in the traverse direction while in, for example, two-layer winding configurations the flipping changes the wire in the vertical direction (i.e. orthogonal to the traverse direction).

Furthermore, methods for manufacturing and using these aforementioned chip choke assemblies are also disclosed.

### Detailed Description of Exemplary Embodiments

It will be recognized that while the following discussion is cast in terms of an exemplary common-mode choke having an I-shaped magnetically permeable core, it would be readily apparent to one of ordinary skill given the present disclosure that same principles apply for a common-mode choke with different magnetically permeable core shapes including, e.g. a C-shaped magnetically permeable core, a square shaped magnetically permeable core, and a rectangular shaped magnetically permeable core.

Furthermore, while the magnetically permeable cores are primarily discussed herein as being formed from a ferrite material, other common core materials can be readily substituted if desired (such as e.g., laminated silicon steel, etc.) to achieve the desired electrical performance characteristics of the chip choke assembly.

### Twisted Windings

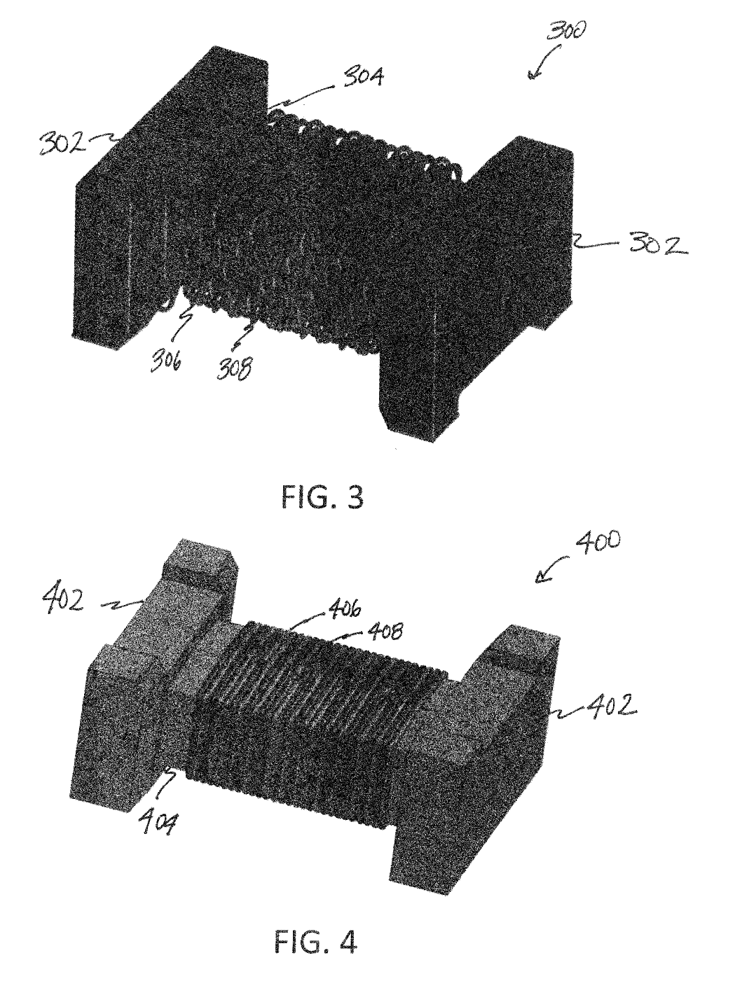

Referring now to FIG. 3, a first exemplary embodiment of a common-mode choke 300 in accordance with the principles of the present disclosure is shown and described in detail. The common-mode choke 300 comprises an I-shaped core with flanges 302 disposed on opposite sides of the winding barrel of core 304. The core 304 is wound, in the illustrated embodiment, with two (2) windings 306, 308. These two (2) windings 306, 308 are twisted about each other prior to their distribution onto the core and wound around the winding barrel of core 304. This technique causes the electrical coupling of a present signal from one turn of a winding to the next turn of the other winding to be continuously changed, and hence, accumulated uneven coupling can be avoided. In other words, this technique minimizes the cumulated undesired electrical coupling within the turns of the common mode choke by randomly changing the areas of coupling so that the net effect can be much more electrically balanced. The ends of this twisted pair windings 306, 308 are subsequently secured to four (4) distinct terminations which are resident on opposite corners of each flange 302.

In an alternative embodiment, more than two (2) wires may be twisted and wound around the core. For example, a woven strand of multiple wires, such as that described in

U.S. Pat. No. 8,405,481 entitled “Woven Wire, Inductive Devices, and Methods of Manufacturing” issued Mar. 26, 2013, which is incorporated herein by reference in its entirety, could be readily added to the core 304.

### Flipped Windings

Referring now to FIG. 4, a second exemplary embodiment of a common-mode choke 400 in accordance with the principles of the present disclosure is shown and described in detail. Similar to the embodiment illustrated above with respect to FIG. 3, the common-mode choke 400 comprises an I-shaped core with flanges 402 disposed on opposite sides of core 404. The winding barrel of core 404 is wound, in the illustrated embodiment, with two (2) windings 406, 408. The windings 406, 408 are wound about the core alternating between one wire 406 and the other 408 with the order of the wire pairs 406, 408 being flipped every few turns about core 404. The flipping of the wire changes the wire order in the traverse direction. This allows the uneven coupling generated by a portion of the windings to reverse direction after every few turns and therefore, nullify the accumulated uneven coupling effects. The number of flips required is dependent upon, for example, the core geometry, the number and size of the wires utilized, and the specification limits on electrical balance. For instance, common-mode chokes that require more balance at higher frequencies need more flips in order to limit the size of the unbalanced sections. This is because the resultant smaller sections will limit the phase of unbalanced signal from becoming too large to be effectively cancelled. As illustrated in FIG. 4, the windings of the wired pair 406, 408 are flipped four (4) times.

However, in an alternative variant, the number of flips is odd (i.e., three (3) flips, five (5) flips, etc.). Using an odd number of flips is particularly useful where the number of turns for each section is the same between flips which would counterbalance the unbalance that has accumulated in the preceding section. Furthermore, while illustrated as having the wire flips occurring in multiple locations on the top portion of the core 404, the location of the wire flips can be readily varied depending upon the electrical requirements for the choke. For instance, flips can occur on the top, bottom, and sides, or even variations thereof on the winding barrel of the core, or anywhere around the circumference of a cylindrical winding barrel.

In a further variant, a pair of the twisted (or braided) windings (such as that illustrated with respect to FIG. 3) is alternatingly wound about the winding barrel of core 404. Each pair of the twisted windings is subsequently flipped periodically about the core 404, similar to that described above with respect to FIG. 4.

### Multiple Layer Windings

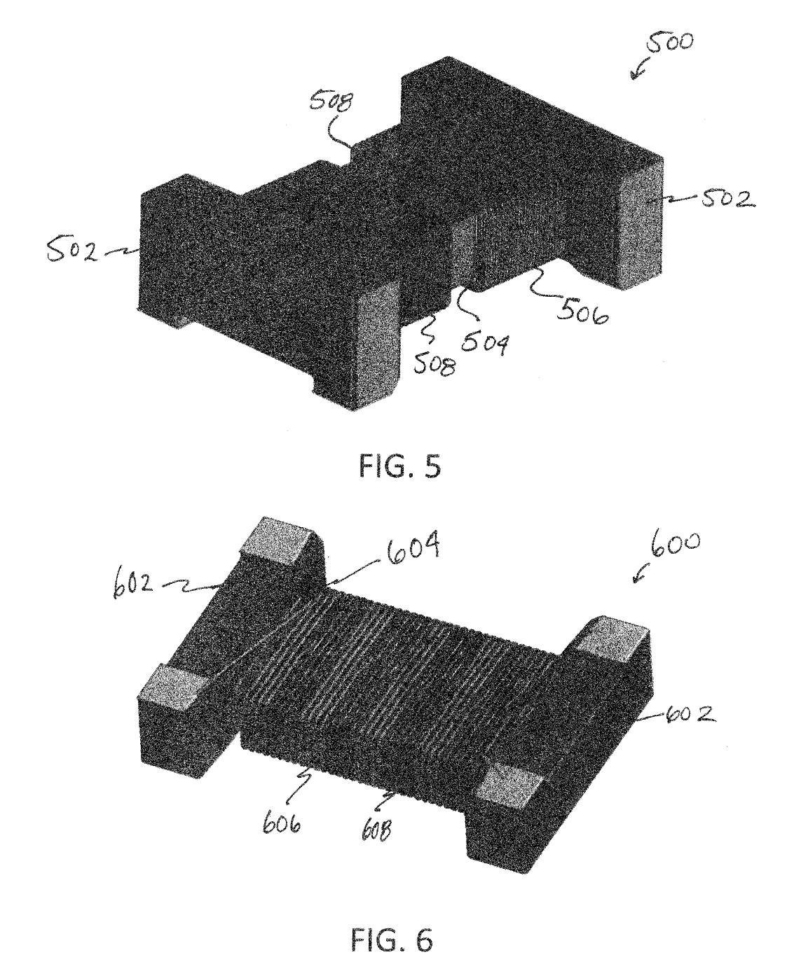

Referring now to FIGS. 5 and 6, wire flipping as discussed above with respect to

FIG. 4 is illustrated with multiple layers of windings of a common-mode choke. As shown in FIG. 5, a first exemplary embodiment of a multiple layer common-mode choke 500 is shown. The choke 500 includes flanges 502 on either side of the winding barrel of core 504. The illustrated choke 500 has two wires 506, 508. On a first portion of the core 504, the first wire 508 is wound adjacent to the core 504. The second wire 506 is wound on top of the first wire 508. In a second portion of the core 504, the second wire 506 is wound adjacent to the core 504 while the first wire 508 is wound on top of the second wire 506. In between the first portion and the second portion the wires 506, 508 are flipped. Flipping the wires 506, 508 in the multiple layer winding reverses the wires in the vertical direction thereby providing better electrical balance. This improved electrical balance is a result of, inter alia, the lengths of the wires 506, 508 being made equal whereas without the flip the inner wire would be shorter than the outer wire.

Referring now to FIG. 6, an alternative embodiment for a multiple layer common mode choke is shown and described in detail. Specifically, the embodiment of FIG. 6 illustrates multiple wire flips as compared with the embodiment of FIG. 5. Like the other embodiments illustrated in FIGS. 3-5, the choke 600 includes flanges 602 on opposite ends of the winding barrel of core 604. In a first portion of the core 604, a first wire 606 is a first distance from the core 604 and a second wire 608 is a second distance from the core 604 where the second distance is longer than the first distance. The positions of the first wire 606 and the second wire 608 switch in a second portion of the winding barrel of core 604 that is adjacent to the first portion via the flipping of the wires 606, 608. In this flipped position, the second wire 608 is now at a first distance from the core 604 while the first wire 606 is at the second distance from the core. The first and second wires 606, 608 alternate distances from the core 604 along the entire length of the winding barrel of core 604. As illustrated in FIG. 6, the first and second wires 606, 608 flip eight (8) times; however, it is of course envisaged that the number of wire flips can vary depending on the particular electrical design constraints, For example, variables such as wire diameter, thickness of the wire coating, dielectric constant of the dielectric itself, and most importantly, the desired balance level, which also varies as a function of frequency are factors to consider in determining the number of wire flips within a given design.

For example, in an alternative variant (and similar to the discussion with respect to the embodiments illustrated in FIGS. 3 and 4), the number of flips is odd (i.e., three (3) flips, five (5) flips, etc.). Using an odd number of flips is particularly useful where the number of turns for each section is the same between flips which would counterbalance the unbalance that has accumulated in the preceding section. Furthermore, while illustrated as having the wire flips occurring in multiple locations on the top portion of the core 604, the location of the wire flips can be readily varied depending upon the electrical requirements for the choke. For instance, flips can occur on the top, bottom, and sides, or even variations thereof on the winding barrel of the core, or anywhere around the circumference of a cylindrical winding barrel.

### Methods of Manufacture

Exemplary methods of manufacture and use of the common-core choke according to the principles of the present disclosure are now described in detail.

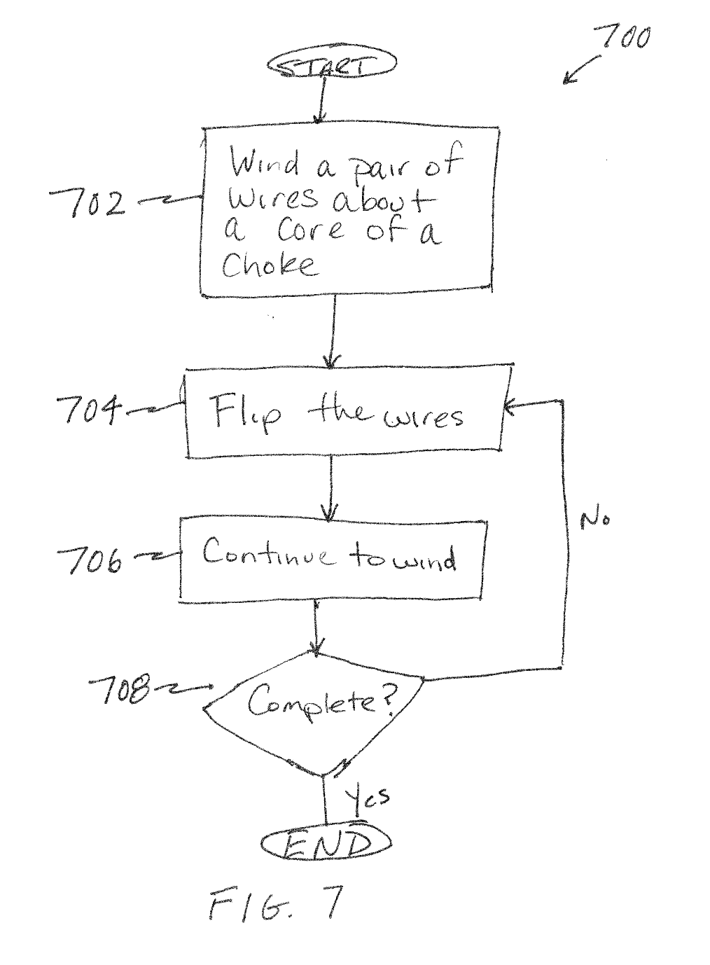

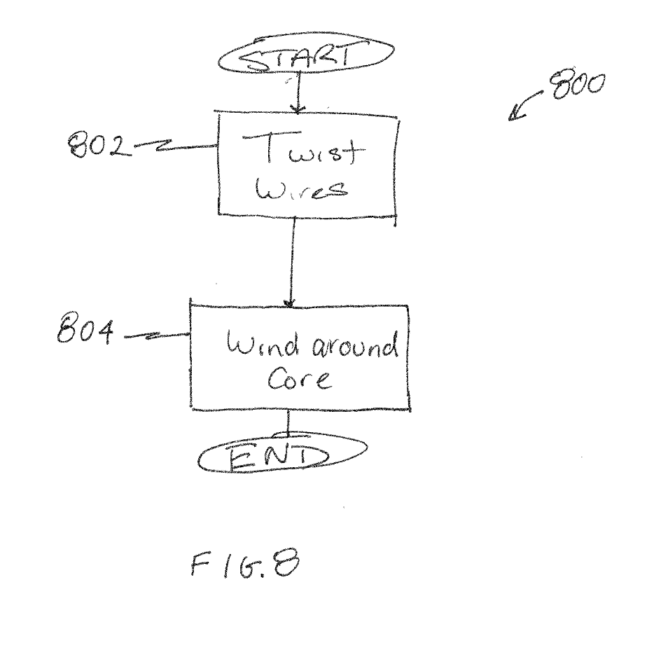

Referring to FIG. 7, an exemplary method for manufacturing 700 the aforementioned common-mode choke is described in detail. The method may be performed by an automated winding machine or alternatively, may be wound by hand. In one embodiment, the core is an I-shaped core of the type illustrated in, for example, FIGS. 3-6. The core thus has an axial portion (i.e., winding barrel) and two (2) flanges disposed on both ends of the axial portion. As discussed previously herein, it will be readily apparent to those skilled in the art without departing from the present disclosure that another shape may be used as required for the final desired shape and properties of the common-mode choke assembly. In one embodiment, the windings used are magnet wire windings with two (2) such windings being wound around the axial portion of the core. In an alternative embodiment, more than two (2) windings are utilized. While the use of the “I” shaped core and square shaped winding barrel are exemplary, other shapes and winding barrel geometries may be formed to get the desired magnetic flux and electrical properties without deviating from the principles of the present disclosure.

At step 702, a pair of wires is wound about a core that is to form the common-mode choke. In a multiple layer variant, the pair of wires is wound vertically about the core such that a first wire of the pair is wound adjacent the core while the second wire of the pair is wound adjacent the first wire.

At step 704, after a predetermined number of windings about the core, the wires are flipped. For example, in the multiple layer variant discussed previously herein, the flipping changes the orientation of the wires in a vertical direction with respect to the winding barrel of the core. Alternatively, in a single layer variant, the flipping of the windings causes the wires to be changed in the horizontal direction (i.e. the traversal direction of the windings) with respect to the core.

At step 706, the pair of wires is continued to be wound with the predetermined orientation governed by step 704.

At step 708, if the number of flips is sufficient to limit the size of unbalanced sections with respect to specification limits on electrical balance, the method 700 ends. Otherwise, the method continues at step 706 where the windings are once again flipped.

Referring now to FIG. 8, an exemplary method for manufacturing 800 an exemplary common-mode choke as illustrated in, for example, FIG. 3 is described in detail.

At step 802, two (2) or more windings are twisted or braided together. In one embodiment, the method of braiding can be done as described in co-owned and co-pending U.S. Pat. No. 8,405,481 entitled “Woven Wire, Inductive Devices, and Methods of Manufacturing” issued Mar. 26, 2013, which was previously incorporated herein by reference in its entirety.

At step 804, the windings are wound onto the length of the winding barrel of a core thereby forming a common-mode choke. In an alternative variant, multiple twisted pairs from step 802 are used as the individual windings of method 800 of FIG. 8.

It will be recognized that while certain aspects of the disclosure are described in terms of specific design examples, these descriptions are only illustrative of the broader methods, and may be modified as required by the particular design. Certain steps may be rendered unnecessary or optional under certain circumstances. Additionally, certain steps or functionality may be added to the disclosed embodiments, or the order of performance of two or more steps permuted. All such variations are considered to be encompassed within the disclosure and claims herein.

While the above detailed description has shown, described, and pointed out novel features of the disclosure as applied to various embodiments, it will be understood that various omissions, substitutions, and changes in the form and details of the device or process illustrated may be made by those skilled in the art. The foregoing description is of the best mode presently contemplated. This description is in no way meant to be limiting, but rather should be taken as illustrative of the general principles of the disclosure, the scope of which should be determined with reference to the claims.

What is claimed is:

1. A common-mode choke, comprising:
a core comprising a winding barrel with two (2) flanges disposed at opposing ends of the winding barrel;
a first winding; and
a second winding;
wherein the first winding and the second winding are wound about the winding barrel of the core such that in a first portion of the winding barrel, the first winding is wound a first distance from the core and the second winding is wound a second distance from the core with the first distance being shorter than the second distance; and
wherein at a second portion of the winding barrel, the first winding and the second winding are flipped such that the second winding is wound the first distance from the core and the first winding is wound the second distance from the core.

2. The common-mode choke of claim 1, wherein the core comprises an I-shaped core.

3. The common-mode choke of claim 2, wherein the first winding and the second winding are flipped a plurality of times along a traversing direction of the winding barrel.

4. The common-mode choke of claim 3, wherein the plurality of times that the first and second windings are flipped is selected such that the common-mode choke has increased balance at a higher frequency than a common-mode choke that does not have the plurality of flips.

5. The common-mode choke of claim 3, wherein the plurality of times comprises an odd number.

6. The common-mode choke of claim 3, wherein the winding barrel comprises a plurality of sides; and
wherein the flips of the first and second windings occur on at least two sides of the winding barrel.

7. The common-mode choke of claim 6, wherein the at least two sides comprises at least two opposing sides of the winding barrel.

8. The common-mode choke of claim 3, wherein the winding barrel comprises a cylindrical winding barrel; and
wherein at least two of the plurality of flips of the first and second windings occur on at least two distinct points along the circumference of the winding barrel.

9. The common-mode choke of claim 1, wherein the first winding and the second winding collectively comprises a twisted winding, the twisted winding comprising a plurality of flips over a given turn.

10. The common-mode choke of claim 9, wherein the twisted winding is secured to a plurality of distinct terminations, each of the distinct terminations occurring on the flanges of the core.

11. The common-mode choke of claim 1, wherein the first winding and the second winding collectively comprise multiple layers of windings about the winding barrel of the core.

12. The common-mode choke of claim 11, wherein a length of the first winding is substantially equal to a length of the second winding.

13. The common-mode choke of claim 11, wherein the winding barrel includes at least a portion of the winding barrel that is substantially free from the first winding and the second winding.

14. A common-mode choke, comprising:
a core comprising a winding barrel with two (2) flanges disposed at opposing ends of the winding barrel;
a first winding; and
a second winding;
wherein the first winding and the second winding are wound about the winding barrel of the core, the wound first and second windings comprising one or more flips.

15. The common-mode choke of claim 14, wherein the one or more flips comprises a plurality of flips, the plurality of flips occurring no more than once per a given turn of the first and second winding.

16. The common-mode choke of claim 14, wherein the one or more flips comprises a plurality of flips, the plurality of flips occurring a plurality of times over a given turn of the first and second winding.

17. The common-mode choke of claim 14, wherein a length of the first winding is substantially equal to a length of the second winding.

18. The common-mode choke of claim 17, wherein the winding barrel includes at least a portion of the winding barrel that is substantially free from the first winding and the second winding.

19. The common-mode choke of claim 17, wherein the first winding and the second winding collectively comprise multiple layers of windings about the winding barrel of the core.

20. A method of manufacturing a common-mode choke, comprising:
obtaining a core having a winding barrel;
obtaining a first conductive wire and a second conductive wire;
winding the first conductive wire and the second conductive wire about the winding barrel of the core;
flipping the first conductive wire and the second conductive wire one or more times as the first and second conductive wires are wound about the winding barrel; and
securing respective ends of the first and second conductive wires to the core.
